(19) United States
(12) Patent Application Publication
(10) Pub. No.: US 2014/0108376 A1
(43) Pub. Date: Apr. 17, 2014

(54) ENHANCED DETECTION OF LIKE RESOURCES

(71) Applicants: John B. Batali, Kirkland, WA (US); Robert F. Day, Bellevue, WA (US); Lars Engebretsen, Zurich (CH); Hartmut Maennel, Zurich (CH); John W. Merrill, Redmond, WA (US); Matthew S. Weaver, Bellevue, WA (US)

(72) Inventors: John B. Batali, Kirkland, WA (US); Robert F. Day, Bellevue, WA (US); Lars Engebretsen, Zurich (CH); Hartmut Maennel, Zurich (CH); John W. Merrill, Redmond, WA (US); Matthew S. Weaver, Bellevue, WA (US)

(73) Assignee: GOOGLE INC., Mountain View, CA (US)

(21) Appl. No.: 12/324,334

(22) Filed: Nov. 26, 2008

(51) Int. Cl. G06F 7/06; G06F 17/30

(52) U.S. Cl. 707/708; 707/E17.014; 707/E17.108

(57) ABSTRACT

Methods, systems, and apparatus, including computer program products, for selecting resources associated with a common topic. In one aspect, a method includes selecting a first resource associated with a topic, the first resource accessed in a user session, selecting a second resource accessed during the user session, determining whether the second resource is associated with the topic, and increasing a relevance score of the second resource and the topic based on determining that the second resource is not associated with the topic.

### BACKGROUND

This specification relates to associating resources with topics.

The rise of the Internet has enabled access to a wide variety of resources, e.g., video files, audio files, web pages for particular subjects, or news articles. Resources can be selected by a search engine in response to a user query. One example search engine is the Google™ search engine provided by Google Inc. of Mountain View, Calif., U.S.A.

Often resources can be grouped in categories based on some feature of the resource. For example, if a website is related to football, it may be associated with a sports category. Categorizing the websites individually though may be time consuming and the websites may be associated with more than one category.

### SUMMARY

In general, a first aspect of the subject matter described in this specification can be embodied in methods that include the actions of selecting a first resource associated with a topic, the first resource accessed in a user session; selecting a second resource accessed during the user session; determining whether the second resource is associated with the topic; and increasing a relevance score of the second resource and the topic based on determining that the second resource is not associated with the topic.

In general, another aspect of the subject matter described in this specification can be embodied in methods that include the actions of selecting a first resource associated with a topic, the first resource accessed during a user session; selecting second resources accessed during the user session; generating a relevance score for each of the second resources based on an external classifier associated with the respective second resource; calculating an average of the relevance scores of the candidate resources; assigning to the first resource the average of the relevance scores as a prediction score; for each second resource, calculating an average of the prediction score of the first resource; assigning to each second resource the average of the prediction score of the first resource as an average prediction score; determining whether the average prediction score of each second resource satisfies a threshold; and associating the respective second resource with the topic based on the determining.

Particular embodiments of the subject matter described in this specification can be implemented so as to realize one or more of the following advantages. Relevance of a resource to a topic can be determined and increased by comparing the resource to other resources that are already known to be associated with the topic.

The details of one or more implementations of the subject matter are set forth in the accompanying drawings and the description below. Other features, aspects and advantages of the subject matter will be apparent from the description, drawings, and claims.

### DESCRIPTION OF DRAWINGS

FIG. 1 is a block diagram showing an example aggregation of new websites corresponding to a user's behavior.

FIG. 2 is a block diagram showing an example online environment.

FIG. 3 is a block diagram showing an example aggregation of websites corresponding to a user's behavior.

FIG. 4 is a flow chart of an example process for associating a resource with a topic.

FIG. 5 is a flow chart of an example process for selecting resources.

FIG. 6 is a flow chart of another example process for selecting resources.

FIG. 7 is a flow chart of an example process for associating resources with topics.

Like reference symbols in the various drawings indicate like elements.

### DETAILED DESCRIPTION

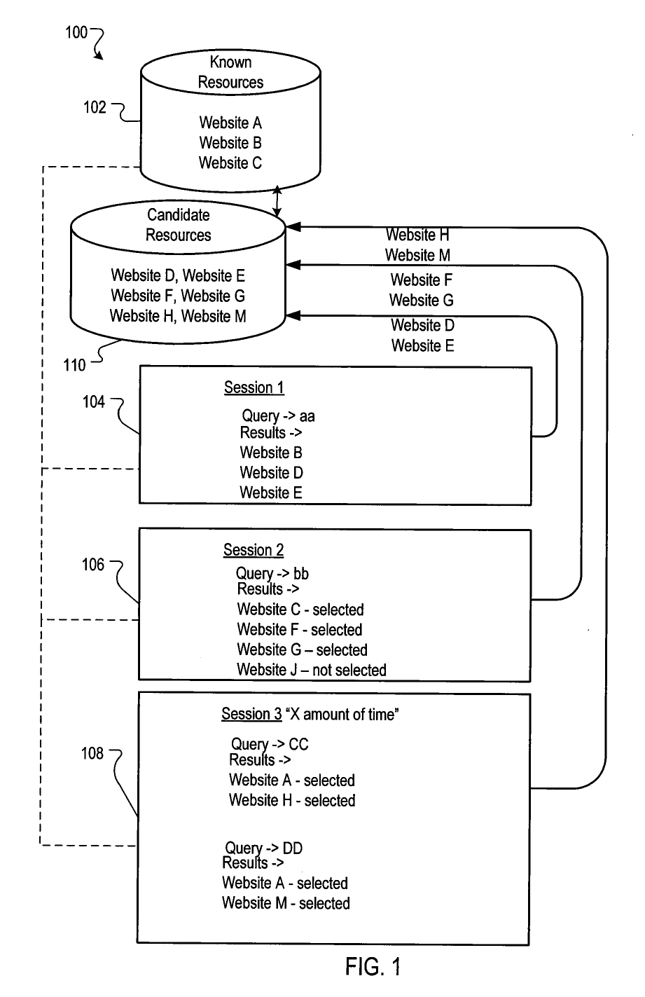

FIG. 1 is a block diagram 100 showing an example aggregation of new resources (e.g., websites) and a set of known resources 102. The term “resource” is used generically to describe video files, audio files, web pages and/or their corresponding websites, news articles, or any other electronic documents that are available on a network (e.g., the Internet). For convenience, a system that is configured to perform the aggregation is described in the context of FIG. 1.

An example system is described in more detail below. In general, when a user provides a search query to a search engine, the search engine uses the search query to select one or more resources located on the network (e.g., the Internet). In addition, a user can browse the Internet to identify one or more resources without first using a search engine. The system may create a user session that the system uses to group data regarding the user's interaction with the resources, search queries provided by the user, or other usage information regarding one or more resources on the network. For example, the data grouped with a user session may include a history of resources accessed, entered search queries, or other historical data associated with the user's actions when using a web browser application.

The user session can include data gathered during a search session where a user submits queries and receives in return one or more resources in response to the search queries. The user session can also include data gathered during a toolbar session where a toolbar plug-in can be installed on the user's browser application and the resources accessed by the user can be gathered. The user session can also be associated with a time period. For example, the data grouped with a toolbar session can include a history of resources accessed and other actions taken by the user during a five minute interval of time or during an entire day. The data gathered from search sessions can include data gathered from any number of queries or during a predetermined period of time. The user session may be stored by the system on storage media attached to the network.

The browser application may present the resources to the user and allow the user to interact with the resources in any number of conventional ways. Example interactions include navigating to other resources by selecting universal resource locator (URL) links, storing resources or portions of resources (e.g., images, music, and movies) on the user's computing device, entering information through one or more user interface components provided by the resource, or other interactions.

A user may access (e.g., visit via t web browser) any number of resources, compose any number of search queries or interact with the browser application in any number of ways in a search session or a toolbar session. The data in the user sessions may be used to select resources that share similar subject matter. By selecting resources that can be associated with the same topic, the system may associate new resources with the set of known resources 102 that are already associated with a topic.

In the depicted example of FIG. 1, the set of known resources 102 are websites. However, the set of known resources 102 can be websites, web pages, other electronic documents or combinations of these. The resources in the set of known resources 102 may be used to enhance future browsing. For example, known resources 102 can include resources that are related to the topic “adult-oriented” and these resources be filtered and not accessible to a minor (e.g., as determined by one more user settings and/or user identification parameters) when the minor is using the browser application to perform a search for resources in a search session or is browsing the Internet in a toolbar session.

The system may initially be configured with a set of known resources 102. The set of known resources 102 can include website addresses, web page addresses, other resource addresses, or combinations thereof. Each set of known resources 102 is associated with a topic. The set of known resources 102 may include a web page address, e.g., www.mysite.com/index.html, a website address e.g., www.mysite.com, or a resource address, e.g., www.mysite.com/index.html/myimage1.jpeg. In some implementations, because website addresses, web page addresses, and resource addresses are contained in the same structure (e.g., HTTP addresses), the system determines one or more of the website addresses, web page addresses from a resource address.

For example, the system can use the resource address www.mysite.com/index.html/myimage1.jpeg to determine a website address (e.g., www.mysite.com) and a web page address (e.g., www.mysite.com/index.html). The set of known resources 102 may be used to determine additional candidate resources 110 that share a common topic with the set of known resources 102. For example, resources that are selected in response to a search query can include known resources 102 as well as new resources. In one implementation, because the new resources were selected in the list containing the known resources, the new resources are added to the set of candidate resources 110 and can potentially be added to the set of known resources 102, as will be described in detail below. The system may store the set of known resources 102 in a database or other computer readable medium.

In some implementations, the system includes any number of sets of known resources 102 and candidate resources 110 associated with any number of topics. For example, the system may include a set of known resources 102 and candidate resources 110 for adult-oriented content, sports related content, politically related content, food related content, education related content, or any other related content.

The system can create any number of user sessions to group the data regarding the user's interaction with resources. In the depicted example illustrated in FIG. 1, the system had created three user sessions 104, 106, and 108. Each user session can also be associated with a topic, the same topic as the candidate resources 110 and the known resources 102. The topic of the user session can be selected based on finding one resource from the known resources 102 in a user session. The known resources 102 and candidate resources 110 in FIG. 1 are associated with a topic, e.g., “adult-oriented,” and already include website A, website B, and website C. Therefore, website A, website B, and website C are known to include information that relates to the topic “adult-oriented.”

In the first created user session 104, the data gathered is associated with a search session including only one query. The user has entered a search query “aa.” The search query is provided to a search engine, which has returned a number of results in response to the search query. In the depicted example, the search query “aa” returned a number of resources: website B, website D, and website E, any of which can be accessed by the user (e.g., by clicking on a corresponding URL link). Website B is not associated with the known resources 102. However, because website B is included in the set of known resources 102, and website B was returned in the search containing websites D and E, the system has added the websites D and E to the set of candidate resources 110.

The system can also increase a relevance score associated with each of the resources in the candidate resources 110 and the topic. For example, websites D and E may initially have a relevance score to the topic of “0”.because these websites are not associated with the known resources 102 associated with the topic “adult-oriented.” Because these websites were selected as candidate resources 110, the score can be increased, for example, by a predetermined amount. The candidate resources 110 can be further analyzed by the system to determine which, if any, of the candidate resources 110 should be added to the set of known resources 102. Various techniques for determining which candidate resources to add to the set of known resources 102 are described in more detail below.

In the second created user session 106, the data gathered reflects another search session including one query and various interactions between the user performing the query and the resources selected. The data shows that the user has entered a search query “bb.” In response, the search engine has returned website C, website F, website G, and website J as results to the search query, any of which may be accessed by the user. Of these four resources, website C is already in the known resources 102. In this example, the user has clicked on a link associated with website C, website F, and website J. Because website C is in the set of known resources 102, and website C was returned in a search containing websites F and G and website C was selected by the user, the system has added websites F and G to the set of candidate resources 110.

In the third created user session 108, a number of user queries are gathered for a predetermined time period during a search session. In the depicted example, the user provides two queries “CC” and “DD” and a number of resources are selected in response to the queries. Website A and website H are selected in response to the query “CC,” and website A and website M are selected in response to the query DD. The user has accessed links to each of these websites during the predetermined time period. Website A is in the set of known resources 102. Because website H was accessed during the same time period as website A, which is included in the set of known resources 102, the system adds website H to the set of candidate resources 110. The system can also increase a relevance score of the website H to the topic associated with the known resources 102. Because website M was accessed during the same time period as website A, the system adds website M to the set of candidate resources 110.

Once the system has generated a set of candidate resources 110, the system can analyze the set of candidate resources 110 to determine which, if any, of the candidate resources 110 should be added to the set of known resources 102. For example, using one or more of the techniques described below, the system adds websites D, E, F, G, H, and M to the set of known resources 102. Whether one of the candidate resources 110 is added to the set of known resources 102 can depend on, for example, whether the relevance score of each of the websites in the set of candidate resources 110 satisfies a predetermined threshold. In some implementations, the system also adds any webpage address associated with the websites D, E, F, G, H, and M to the set of known resources 102.

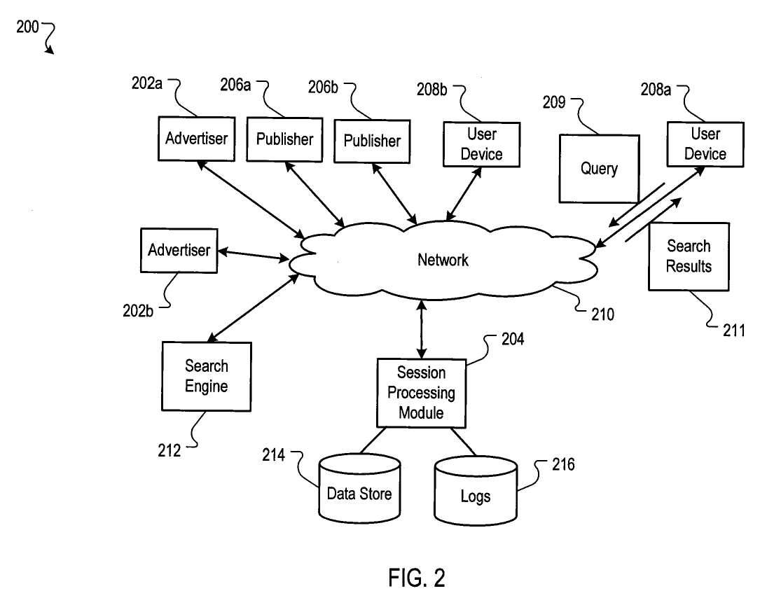

FIG. 2 is a block diagram of an example online environment 200. The online environment 200 may facilitate the selection and serving of resources (e.g., web pages, advertisements, or other content) to users. A computer network 210, e.g., a local area network (LAN), wide area network (WAN), the Internet, or a combination thereof, connects advertisers 202a and 202b, a search engine 212, publishers 206a and 206b, user devices 208a and 208b, and a session processing module 204. Example user devices 208 include personal computers, mobile communication devices, or television set-top boxes. Although only two advertisers (202a and 202b), two publishers (206a and 206b) and two user devices (208a and 208b) are shown, the online environment 200 may include any number of advertisers, publishers and user devices. Additionally, the on-line environment may include any number of session processing modules 204.

The publishers can be general content servers that receive requests for resources (e.g., web pages or documents related to articles, discussion threads, music, video, graphics, other web page listings, information feeds, product reviews, or other resources), and retrieve the requested resources in response to the request. For example, content servers related to news content providers, retailers, independent blogs, social network sites, products for sale, or any other entity that provides content over the network 210 may be a publisher.

A user device, e.g., user device 208a, may submit a query 209 to the search engine 212, and search results 211 may be provided to the user device 208a in response to the query 209. The search results 211 may include a URL link to web pages provided by the publishers 206a and 206b.

To facilitate selection of the search results in response to queries, the search engine 212 may index the content provided by the publishers 206 (e.g., an index of web pages) for later search and retrieval of search results that are relevant to the queries. An exemplary search engine 212 is described in S. Brin and L. Page, “The Anatomy of a Large-Scale Hypertextual Search Engine,” Seventh International World Wide Web Conference, Brisbane, Australia (1998) and in U.S. Pat. No. 6,285,999. Search results may include, for example, lists of web page titles, snippets of text extracted from those web pages, and hypertext links to those web pages, and may be grouped into a predetermined number (e.g., ten) of search results. In addition, in some implementations, the search engine 212 uses a set of known web pages, or websites, to filter search results corresponding to related subject matter.

In some implementations, the user session can be created and defined by a number of search sessions or toolbar sessions. Each search session can be determined by a number of queries or a time period for any number of searches in the search session. Each toolbar session can be determined by a predetermined time period the user browses the Internet using a browser with a toolbar plug-in installed. For example, during a predetermined time period, multiple search queries may be submitted to the search engine 212, and one user session can be created from the gathered data. For example, if a particular user device 208a submits a query, a current user session can be initiated. The current user session may be terminated when the search engine 212 has not received further queries from the user for a predetermined time period (e.g., 5-10 minutes). In some implementations, the user session is defined by a user indicating the beginning and end of a user session (e.g., by logging into a search engine interface of the search engine 212 and logging out of a search engine interface). Other ways of creating a user session may also be used.

The search engine 212 may provide the created user sessions to the session processing module 204. The session processing module 204 may store a predetermined set of known resources 102 for one or more topics in the data store 214. Moreover, the data store 214 may also include candidate resources 110 that have not been incorporated into the set of known resources 102 for each topic. In addition, the session processing module 204 may store user sessions in logs 216.

In some implementations, the session processing module 204 selects particular user sessions that can potentially be related to a particular topic. For example, if there is a set of known resources 102 that corresponds to sports related content, and a user accesses one of the resources in the set of sports related content resources (e.g., in a particular user session), the session processing module 204 can the particular user session as potentially relating to the topic sports. The session processing module 204 may analyze the user sessions to determine if any resources should be added to the candidate resources 110, and if any candidate resources 110 should be added to a set of known resources 102.

In some implementations, if the data in a user sessions shows search results selected in response to a query include at least one resource in the set of known resources 102 associated with a particular topic, the session processing module adds the other resources in the search results to the set of candidate resources 110 associated with the same topic. The user session can be associated with any number of queries as described above or a predetermined time period. Therefore, if the user session was associated with five queries, and each of those queries returned resources in the set of known queries, the rest of the resources in the search results are added to the set of candidate resources.

In some implementations, the data in a user session can include search results selected in response to a single query. If the search results include at least one resource in the set of known resources 102 associated with a particular topic, and that particular resource was accessed by the user, then the session processing module 204 can add the remaining resources in the search results to the set of candidate resources 110 associated with the same topic.

In other implementations, the data in a user session can be associated with one or more queries executed during a predetermined period of time. If the search results include at least one resource in the set of known resources 102 associated with a particular topic, and that particular resource was accessed b the user, then the session processing module can add the remaining resources in the search results to the set of candidate resources 110 associated with the same topic.

In some implementations, each time a resource is added to the set of candidate resources 110, the relevance score associated with the resource to the topic associated with the candidate resources 110 can be increased. The relevance score indicates a degree of relevance of each resource to a topic. The relevance score can, for example, be increased by a percentage amount or a predetermined weighted amount. The amount of the increase can be determined by a number of features such as for example, how far up in the search results the resource appeared. The relevance score can also be increased each time the candidate resource appears in another user session associated with the same topic.

For example, each resource in the set of known resources 102 is assigned a relevance score of 1.0, on a scale between 0 and 1.0 Each of the resources can be assigned an initial relevance score of 0.0 until the resources are added to the candidate resources 110. After being added to the candidate resources 110, the relevance score of each of the resources added can be increased by a predetermined amount. For example, since website F was added to the candidate resource 110 in FIG. 1, the relevance score of website F associated with the candidate resources can be increased by a weight of “0.1.” So, if the relevance score of website F as it relates to the topic associated with the candidate resources 110 was previously “0,” now the relevance score is “0.1.” If in another user session the same resource was added to the set of candidate resources 110, the relevance score can be increase by “0.1” again so it will equal “0.2.” In some implementations, the candidate resources 110 can be added to the known resources if the relevance scores exceed a predetermined threshold. For example, if the relevance score exceeds 0.4, the resource can be moved from the set of candidate resources 110 to the set of known resources 102.

In some implementations, the session processing module 204 removes candidate resources associated with a certain topic that also appear as candidate resources associated with another topic. For example, if one or more websites have been added to candidate resources associated with the topics “baseball” as well as “Atlanta,” these websites can be removed from both the candidate resources relating to the topic “baseball” and the candidate resources relating to the topic “Atlanta.” In some implementations, removing a resource from candidate resources also decreased the relevance score of the resource to the topic by the same amount the relevance score was increased when it was initially added.

In some implementations, the session processing module 204 analyzes the queries issued during a created user session to remove candidate resources 110. For example, for a particular user session, the sequence of queries includes queries that returned resources from the set of known resources 102, and queries that do not return resources from the set of known resources 102. The queries that returned resources from the set of known resources 102 include particular search terms (designated as the set of search terms K). Using the set of search terms K, the session processing module 204 may remove candidate resources 110 that are selected but found without using at least one search term from the set of search terms K. In some implementations, the session processing module 204 removes candidate resources 110 that are found using queries that do not include all of the search terms in the set of search terms K.

In some implementations, the session processing module 204 computes a topic weight for each query term that returns resources from the set of known resources 102. For example, if a set of baseball topic terms “baseball,” “grand-slam home run,” and “seventh inning stretch” always results in search results including the set of known resources 102, each of these terms can be associated with a topic weight of “1.” Therefore, any time these query terms are used in search queries, any of the resources returned in the search results can be added to the set of candidate resources 110.

In some implementations, the session processing module 204 computes a ranking of the candidate resources 110 according to a frequency in which the candidate resources appear in a first user session associated with a first topic versus another a second user session associated with a second topic. The ranking can be used to modify the relevance score associated with each candidate resource. For example, candidate resources associated with “baseball” can appear more often in a user session associated with “sports” than in a user session associated with “baseball.” Since the frequency that these candidate resources appear in the “sports” related user session is higher, these candidate resources can be demoted in ranking by a decrease in relevance score as they appear in the candidate resources associated with “baseball.”

The ranking function may also use the topic weights for search terms, as described above. For example, candidate resources that appear in sessions that are selected using search terms associated with high topic weights may be weighted higher than candidate resources that appear in sessions that are found using the search terms that are not associated with high topic weights.

In some implementations, the session processing module 204 uses classifiers associated with the candidate resources to determine if the resources should be added to the known resources 102. The classifiers can include text, images, links, HTML tags, fonts, colors, titles, URLs associated with each resource. Each classifier can be associated with a different weight. Candidate resources associated with a known resource 102 can be assigned a relevance score based on the classifiers. For example, suppose website L and website X are known resources 102. Website M and website N are selected in the search results along with website L, and therefore, website M and website N are candidate resources 110. Websites M and Y selected in the search results along with website X, and therefore Y is also added as a candidate resource (website B was already added as a candidate resource.)

Websites M, N, and Y can be assigned a relevance score based on classifiers associated with each website. If the topic of the known resources 102 was “food,” website M may be assigned a relevance score of “0.5” because of images of food on the website, website N may be assigned a relevance score of “0.7” because of the words “fruit,” and “vegetable” on the website, and website Y can be assigned a relevance score of “0.3” because of an image of oatmeal.

The session processing module 204 can then average the relevance scores of the candidate resources related to each known resource. In this example, the relevance scores for website M, “0.5” and website N, “0.7” can be averaged to equal “0.6.” This average of 0.6 is assigned to website L and it is a measure of how well website L predicts the topic of its related resources. The relevance scores for website M, “0.5” and website Y, “0.3” can be averaged to equal “0.4.” This average is assigned to website X.

The session processing module 204 can then average the averaged relevance scores for each candidate resource 110. Therefore, for website M, the session processing module can average the scores of website L, which is “0.6” and website X, which is “0.4” to equal 0.5. This is the final score for M which reflects its relation to website L and website X, the relation of website L and website X to the other candidate sites, and the initial scores for these other candidate sites. For website N, there is only one averaged relevance score of “0.6” since website N was only related to website L and not X. For website Y, there exist only one averaged relevance score of “0.4” since website Y was only related to website L, not to website X. Websites M, N, and X now have relevance scores of “0.5,” “0.6”, and “0.4,” respectively. If these averages are above a predetermined threshold, then the respective candidate resource 110 can be added to the set of known resources 102 for example, if the threshold in this example was “>=0.6,” then website N, with a relevance score of “0.6,” can be added to the set of known resources 102 related to “food.”

In some implementations, the session processing module 204 removes certain candidate resources that include topics that are generally considered to provide false-positive classifications for topics associated with a user session. For example, an image classifier that is used to identify adult-oriented content may inadvertently classify non-adult oriented pictures with lots of skin (e.g., bikini shops, tattoo salons, or dermatology websites) as adult oriented content. Consider a set T of topics that have been selected to contain false-positives. For example, a text classifier may be used to classify a set of resources and human raters may review the results to remove wrongfully classified resources and manually add them to the set T. To ensure that each of the resources in the set T does not contain on-topic material, the session processing module 204 may use an on-topic classifier to detect resources that may be on-topic. Resources that are considered to be on-topic may be removed or manually looked at by a human rater.

In some implementations, to reduce false-positives for topic detection, the session processing module 204 determines, for each candidate resource, a set of related resources. For example, the session processing module 204 may determine a set of related resources for a particular candidate resource based on if the related resources are found using the same query as the candidate resource, or if the related resources are accessible from the candidate resource through one or more URL links. If the candidate resource's related resources have a large fraction (e.g., at least 50%) of resources in the set of topics T, then the candidate resource is probably related to off-topic material and may be either removed or further scrutinized by human raters.

In some implementations, any or all of the techniques described above may be used to resolve a topic conflict. For example, consider a situation where text and image classifiers determine that a resource includes two potential topics. Any or all of the techniques described above may be executed one or more times to remove resources from the candidate resources of a first topic if the session processing module 204 selects the same resource in the candidate resources of a second topic.

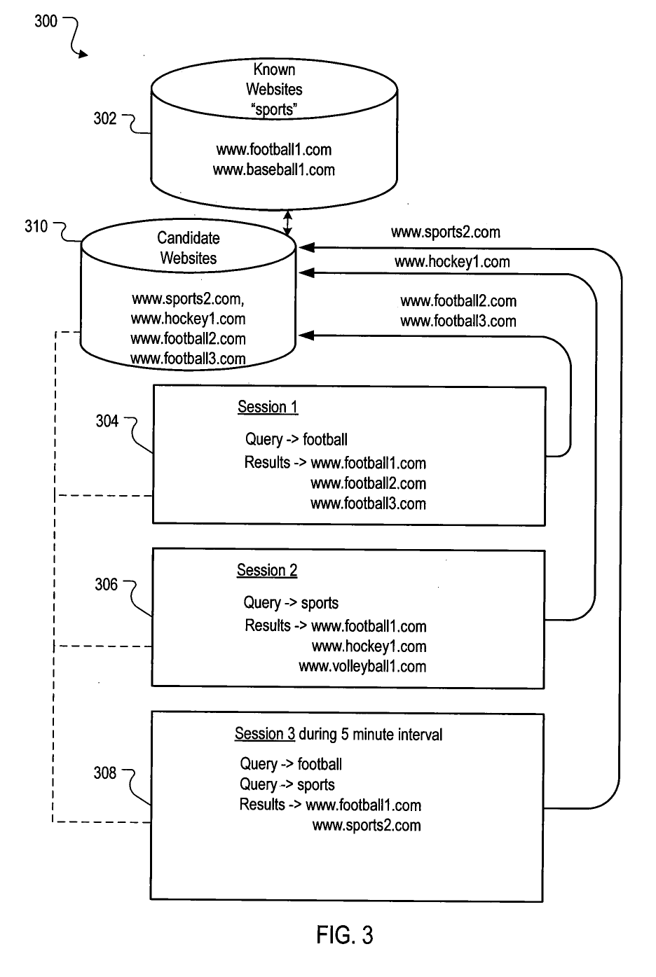

FIG. 3 is a block diagram showing an example aggregation 300 of sports websites. For convenience, the online environment 200 is used to describe the aggregation 300 depicted in FIG. 3. In the example of FIG. 3, the resources are described as websites. The example depicted in FIG. 3 relates to websites related to the topic “sports.” The known websites 302 related to the topic “sports” are www.football1.com, www.baseball1.com, and www.soccer1.com.

A first user session 304 is created that shows the results of a single search session. The user has provided the search query “football” to search engine 212 through network 210. The search engine 212 may select any number of results that are responsive to the search query. In this example, a number of websites www.football1.com, www.football2.com, and www.football3.com are selected in response to the user query. The first user session 304 may be transmitted to the session processing module 204 over network 210. The session processing module 204 may analyze the user session to generate a set of candidate websites 310.

For example, the session processing module 204 has analyzed user session 304 and added www.football2.com and www.football3.com to the set of candidate websites 310 because websites www.football2.com and www.football3.com are returned as search results along with a website in the set of known websites 302 (e.g., www.football1.com). Alternatively, in some implementations, the session processing module 204 may aggregate data from multiple user session to construct the set of candidate websites 310. In such implementations, the session processor module 204 stores the data from the user sessions in the logs 216.

For example, after the session processing module 204 received the data from the first user session 306 and stored it in the logs 216, a second user session 306 is created corresponding to the data from another search session. A search query “sports” entered by a user and the search results www.football1.com, www.hockey1.com, and www.volleyball1.com in response to the query are selected. A user has accessed a link associated with the website www.hockey1.com. Because the website www.hockey1.com was accessed, the session processing module 204 adds the website www.hockey1.com to the candidate website 310. The second user session 306 may also be stored in the logs 216.

Additionally, a third user session 308 is generated that corresponds to a search session and search queries and events having occurred during a five minute period of time. During the course of the five-minute interval, the user has provided two queries, “football” and “sports,” and a number of results have been returned in response to the queries including www.football1.com and www.sports2.com. During the five minute interval, the user clicked on the website www.sports2.com, and therefore, because the website www.football1.com was returned as a search result and was in the known website 302, and www.sports2.com is added to the candidate websites 310.

Therefore, the websites www.football2.com, www.football3.com, www.hockey1.com, and www.sports2.com are added as candidate websites 310. Each of these candidate websites can be associated with a relevance score associating the website with the topic associated with the candidate websites 310 and known website 302. In this example, the relevance score measures the relevance of each candidate website 310 with the topic “sports.” Initially these websites had a relevance score of “0” but by being added to the candidate websites 310, each of the relevance scores can be increased by “0.10.” If these same websites are added again to the candidate websites 310, instead of re-adding the website, the relevance score can be increased. Once the relevance score of one or more of the candidate websites 310 exceeds or satisfies a predetermined threshold, the respective candidate website 310 can be added to the set of known websites 302 relating to the topic “sports.”

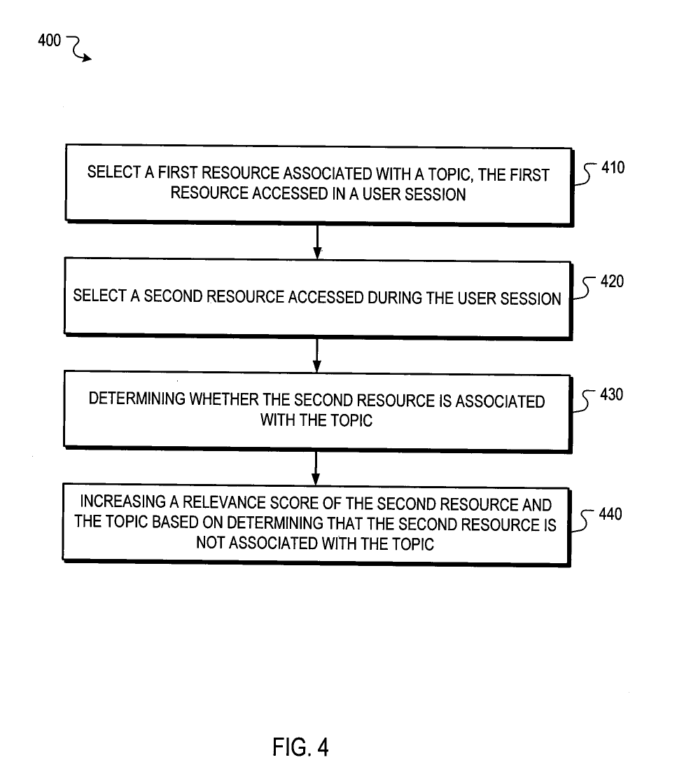

FIG. 4 is a flow chart of an example process 400 for associating a resource with a session. For convenience, process 400 is described in reference to the session processing module 204. However, other systems or processing modules may execute process 400.

Stage 410 selects a first resource associated with a topic, the first resource accessed in a user session. For example, the session processing module 204 can select a first resource associated with a topic, the first resource accessed in a user session.

Stage 420 selects a second resource accessed during the user session. For example, the session processing module 204 can select a second resource accessed during the user session.

Stage 430 determines whether the second resource is associated with the topic. For example, the session processing module 204 can determine whether the second resource is associated with the topic.

Stage 440 increases a relevance score of the second resource and the topic based on determining that the second resource is not associated with the topic. For example, the session processing module 204 can increase a relevance score of the second resource and the topic based on determining that the second resource is not associated with the topic.

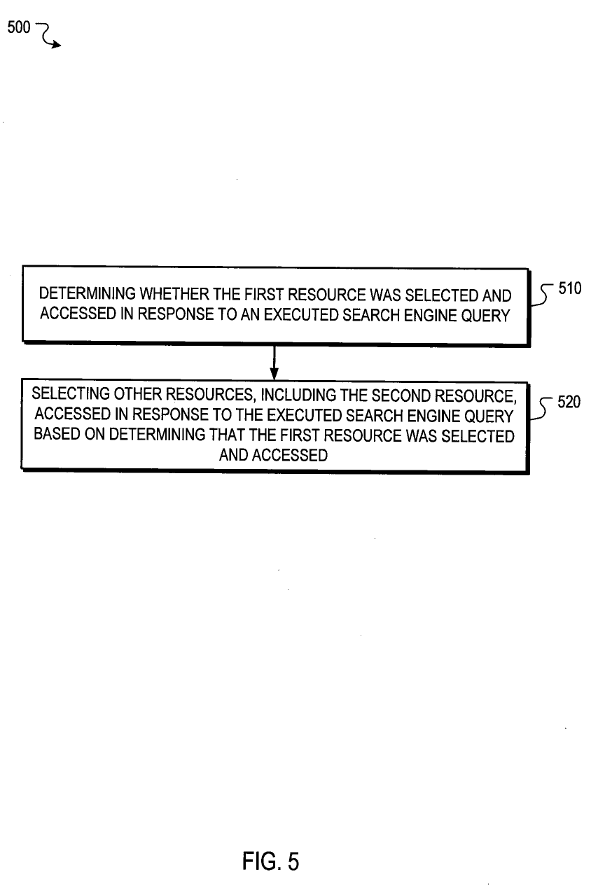

FIG. 5 is a flow chart of an example process 500 for selecting resources. For convenience, process 500 is described in reference to the session processing module 204. However, other systems or processing modules may execute process 500.

Stage 510 determines whether the first resource was selected and accessed in response to an executed search engine query. For example, session processing module 204 can determine whether the first resource was selected and accessed in response to an executed search engine query.

Stage 520 selects other resources, including the second resource, accessed in response to the executed search engine query based on determining that the first resource was selected and accessed. For example, the session processing module 204 can select other resources, including the second resource, accessed in response to the executed search engine query based on determining that the first resource was selected and accessed.

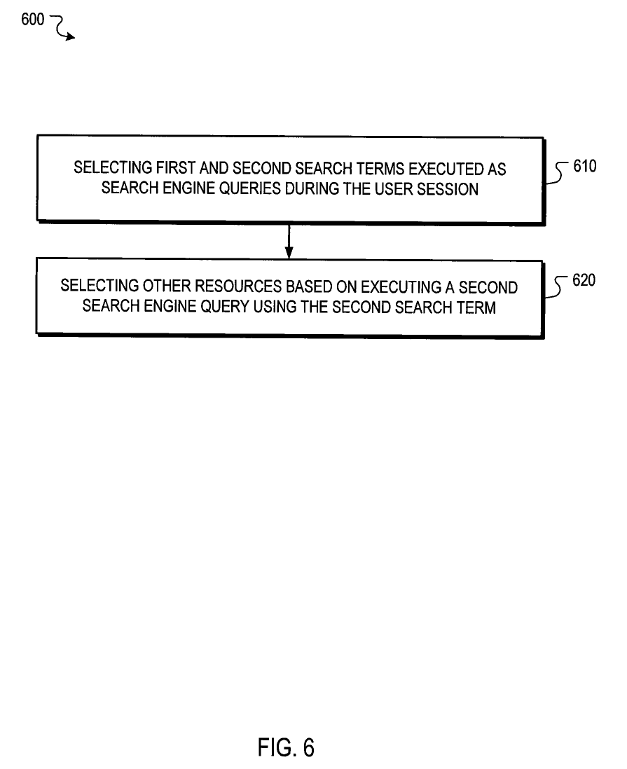

FIG. 6 is a flow chart of an example process 600 for selecting other resources. For convenience, process 600 is described in reference to the session processing module 204. However, other systems or processing modules may execute process 600.

Stage 610 selects first and second search terms executed as search engine queries during the user session, the first search term executing a first search engine query selecting the first resource. For example, the session processing module 204 can select first and second search terms executed as search engine queries during the user session, the first search term executing a first search engine query selecting the first resource.

Stage 620 selects other resources based on executing a second search engine query using the second search term, wherein the selected second resource is associated with the topic only if determining that the other resources includes the selected second resource. For example, the session processing module 204 can select other resources based on executing a second search engine query using the second search term.

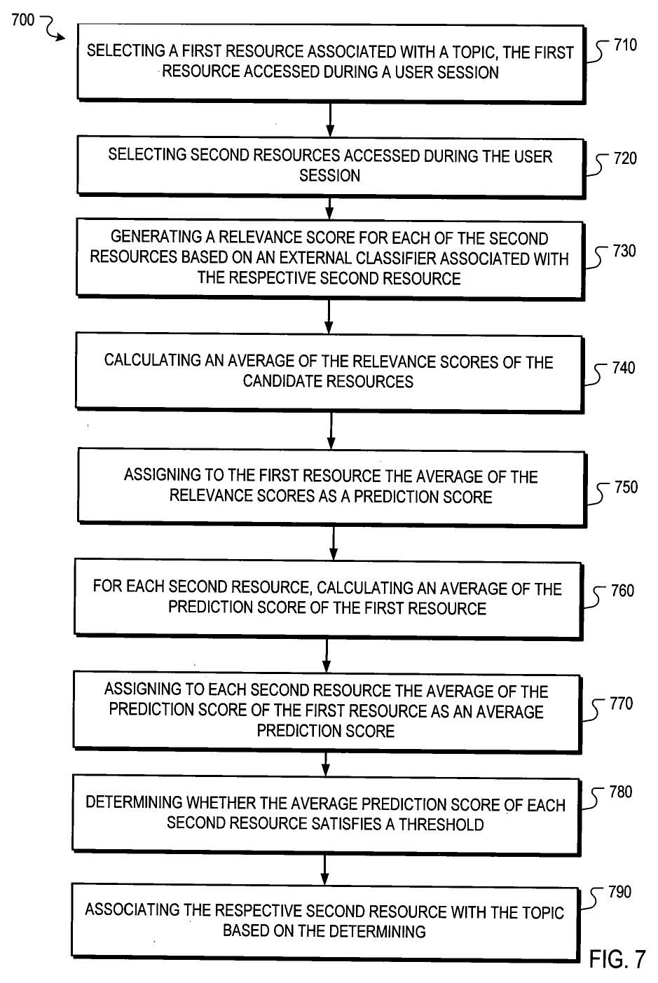

FIG. 7 is a flow chart of an example process 700 for associating resources with topics. For convenience, process 700 is described in reference to the session processing module 204. However, other systems or processing modules may execute process 700.

Stage 710 selects a first resource associated with a topic, the first resource accessed during a user session. For example, the session processing module 204 can select a first resource associated with a topic, the first resource accessed during a user session.

Stage 720 selects second resources accessed during the user session. For example, the session processing module 204 can select second resources accessed during the user session.

Stage 730 generates a relevance score for each of the second resources based on an external classifier associated with the respective second resource. For example, the session processing module 204 can generate a relevance score for each of the second resources based on an external classifier associated with the respective second resource.

Stage 740 calculates an average of the relevance scores of the candidate resources. For example, the session processing module 204 can calculate an average of the relevance scores of the candidate resources.

Stage 750 assigns to the first resource the average of the relevance scores as a prediction score. For example, the session processing module 204 can assign to the first resource the average of the relevance scores as a prediction score.

Stage 760 calculates, for each second resource, an average of the prediction score of the first resource. For example, the session processing module 204 can calculate, for each second resource, an average of the prediction score of the first resource.

Stage 770 assigns to each second resource the average of the prediction score of the first resource as an average prediction score. For example, the session processing module 204 can assign to each second resource the average of the prediction score of the first resource as an average prediction score.

Stage 780 determines whether the average prediction score of each second resource satisfies a threshold. For example, the session processing module 204 can determine whether the average prediction score of each second resource satisfies a threshold.

Stage 790 associates the respective second resource with the topic based on the determining. For example, the session processing module 204 can associate the respective second resource with the topic based on the determining.

Embodiments of the subject matter and the functional operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer program products, i.e., one or more modules of computer program instructions encoded on a tangible program carrier for execution by, or to control the operation of, data processing apparatus. The tangible program carrier may be a propagated signal or a computer readable medium. The propagated signal is an artificially generated signal, e.g., a machine-generated electrical, optical, or electromagnetic signal that is generated to encode information for transmission to suitable receiver apparatus for execution by a computer. The computer readable medium is a machine-readable storage device, a machine-readable storage substrate, a memory device, a composition of matter affecting a machine-readable propagated signal, or a combination of one or more of them.

The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any form of programming language, including compiled or interpreted languages, or declarative or procedural languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter described in this specification have been described. Other embodiments are within the scope of the following claims. For example, the actions recited in the claims may be performed in a different order and still achieve desirable results. As one example, the processes depicted in the accompanying figures do not necessarily require the particular order shown, or sequential order, to achieve desirable results.

What is claimed is:

1. A computer-implemented method comprising:
identifying a selection of a first search result in each of plurality of sessions, wherein for each session a respective user of the session selected the first search result during the session and wherein the first search result was provided in response to a first query submitted to a search engine during the session;
determining that the first search result identified a first resource that is associated with a topic and, based on the determining, associating each of the plurality of sessions with the topic;
for each session of the plurality of sessions, determining that the respective user of the session had selected one or more respective second search results in the same session, wherein each second search result identified a respective second resource that is different from the first resource;
increasing a respective topic relevance score for each of the second resources identified by a respective second search result based on the association of a session in which the respective second search result was selected with the topic, and wherein the second search result was provided in response to a respective second query and wherein the second query is different than the first query for which the first search result of the session was responsive;
identifying second resources having respective topic relevance scores that exceed a threshold; and
associating the identified second resources with the topic.

2-3. (canceled)

4. The method of claim 1 wherein each of the second search results was selected within a predetermined period of time following the selection of the first search result in the session.

5-8. (canceled)

9. The method of claim 1 wherein the first search result and the second search results identify websites.

10. The method of claim 1, wherein the user session comprises a search session or a toolbar session.

11. (canceled)

12. A system comprising:
data processing apparatus configured to perform operations comprising:
identifying a selection of a first search result in each of plurality of sessions, wherein for each session a respective user of the session selected the first search result during the session and wherein the first search result was provided in response to a first query submitted to a search engine during the session;
determining that the first search result identified a first resource that is associated with a topic and, based on the determining, associating each of the plurality of sessions with the topic;
for each session of the plurality of sessions, determining that the respective user of the session had selected one or more respective second search results in the same session, wherein each second search result identified a respective second resource that is different from the first resource;
increasing a respective topic relevance score for each of the second resources identified by a respective second search result based on the association of a session in which the respective second search result was selected with the topic, and wherein the second search result was provided in response to a respective second query and wherein the second query is different than the first query for which the first search result of the session was responsive;
identifying second resources having respective topic relevance scores that exceed a threshold; and
associating the identified second resources with the topic.

13-14. (canceled)

15. The system of claim 12 wherein each of the second search results was selected within a predetermined period of time following the selection of the first search result in the session.

16-18. (canceled)

19. The system of claim 12 wherein the first search result and the second search results identify websites.

20. A non-transitory computer-readable medium encoded with instructions that, when executed by data processing apparatus, cause the data processing apparatus to perform operations comprising:
identifying a selection of a first search result in each of plurality of sessions, wherein for each session a respective user of the session selected the first search result during the session and wherein the first search result was provided in response to a first query submitted to a search engine during the session;
determining that the first search result identified a first resource that is associated with a topic and, based on the determining, associating each of the plurality of sessions with the topic;
for each session of the plurality of sessions, determining that the respective user of the session had selected one or more second search results in the same session, wherein each second search result identified a respective second resource that is different from the first resource;
increasing a respective topic relevance score for each of the second resources identified by a respective second search result based on the association of a session in which the respective second search result was selected with the topic, and wherein the second search result was provided in response to a respective second query and wherein the second query is different than the first query for which the first search result of the session was responsive;
identifying second resources having respective topic relevance scores that exceed a threshold; and
associating the identified second resources with the topic.

21. The computer-readable medium of claim 20 wherein each of the second search results was selected within a predetermined period of time following the selection of the first search result in the session.

22. (canceled)

23. The computer-readable medium of claim 20 wherein the first search result and the second search results identify websites.

24. The computer-readable medium of claim 20 wherein the user session is defined by a period of time.

25. The computer-readable medium of claim 20 wherein the user session is a search session or a toolbar session.

26. The method of claim 1 wherein the user session is defined by a period of time.

27. (canceled)

28. The system of claim 12 wherein the user session is defined by a period of time.

29. The system of claim 12 wherein the user session is a search session or a toolbar session.

30. The method of claim 1, wherein the first search result in each of the plurality of sessions was provided in response to different respective first queries submitted to the search engine.

31. The of system of claim 12, wherein the first search result in each of the plurality of sessions was provided in response to different respective first queries submitted to the search engine.

32. The computer-readable medium of claim 20, wherein the first search result in each of the plurality of sessions was provided in response to different respective first queries submitted to the search engine.

33. The method of claim 1 wherein the second search result was provided in response to a respective second query and wherein the second query had at least one term in common with the first query for which the first search result of the session was responsive.

34. The system of claim 12 wherein the second search result was provided in response to a respective second query and wherein the second query had at least one term in common with the first query for which the first search result of the session was responsive.

35. The computer-readable medium of claim 20 wherein the second search result was provided in response to a respective second query and wherein the second query had at least one term in common with the first query for which the first search result of the session was responsive.

36. The method of claim 1 wherein determining that the first search result identified a first resource that is associated with a topic comprises:
determining that each of the respective first queries include a term that is associated with the topic.

37. The system of claim 12 wherein determining that the first search result identified a first resource that is associated with a topic comprises:
determining that each of the respective first queries include a term that is associated with the topic.

38. The computer-readable medium of claim 20 wherein determining that the first search result identified a first resource that is associated with a topic comprises:
determining that each of the respective first queries include a term that is associated with the topic.
